(19) United States
(12) Patent Application Publication
(10) Pub. No.: US 2008/0136200 A1
(43) Pub. Date: Jun. 12, 2008

(54) ELECTRIC DOOR OPENER FOR GLASS DOORS

(75) Inventor: Norman WITTKE, Albstadt (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: ASSA ABLOY Sicherheitstechnik GmbH

(21) Appl. No.: 11/962,365

(22) Filed: Dec. 21, 2007

Related U.S. Application Data
(63) Continuation of application No. PCT/EP2006/004503, filed on May 12, 2006.

(30) Foreign Application Priority Data
Jun. 22, 2005 (DE) DE 102005028957.6

(51) Int. Cl. E05F 15/00

(52) U.S. Cl. 292/341.16

(57) ABSTRACT

The invention describes an electric door opener for glass doors, having a pivotable door opener latch comprising a holder, and a mating holder, with the holder and the mating holder delimiting a receiving region for receiving a glass door leaf. In order to simplify installation and improve storage, the door opener is designed such that the holder is provided with an adjustable configuration to ensure adjustability of the width of the receiving region.

### CROSS-REFERENCE TO RELATED APPLICATIONS

This application is a continuation of International Application No. PCT/EP2006/004503 filed on May 12, 2006, which designated the United States, which application claims priority of DE 102005028957.6 filed Jun. 22, 2005. The disclosure of each application is hereby incorporated by reference in their entirety.

### BACKGROUND OF THE INVENTION

The invention relates to an electric door opener for glass doors, comprising a pivotable door opener latch comprising a holder, and a mating holder, with the holder and the mating holder delimiting a receiving region for receiving a glass door leaf.

As is generally known, door openers are used in door closing systems of residential or office buildings. Electric door openers generally comprise a pivot latch which can be released or blocked by means of a stop lever (switchover) through an electric positioning element, especially an electromagnet.

Glass doors for installation in buildings were used more and more in the past years for reasons of design. Glass doors shall be understood in the following as doors where the leaf is made of glass. In addition, the frame of the door can also consist of glass. They are then often called full glass doors. The door openers need to be adjusted according to the special material and shaping properties of glass doors. It is known to provide a receiving region in the door opener latch in which a portion of the boundary area of a glass door leaf can be received. In order to delimit this receiving region it is further known to provide a holder on the pivot latch and a mating holder on the latch or the door opener housing. The holder and mating holder each lie on opposite sides of the door leaf edge, so that a kind of overlap of the door leaf edge by the receiving region is obtained. Holder and mating holder can be formed by projections protruding from the latch or door opener. When the pivot latch is blocked, the glass door leaf is held by the receiving region and is unable to slide out of the latch. When the latch is released, the same is pivotable and the glass door leaf can slide out of the same. Frequently, the latch body is subjected to a spring force, so that the pivot latch remains for such a time in the pivoted position until the door leaf slides into the receiving region and presses the pivot latch into the closed position against the force of the spring.

Problems in installation and storage arise due to the large variety of types and the special requirements posed by the material on glass doors.

### SUMMARY OF THE INVENTION

The invention is based on the object of providing a door opener of the kind mentioned above which is as simple as possible to install and can be used for a large number of types of glass doors. This object is achieved in such a way that the holder arranged on the pivotable door opener is provided with an adjustable configuration so that the width of the receiving region is adjustable. Advantageous embodiments of the invention are shown in the dependent claims.

The principal idea of the invention is provide at least the holder with a movable configuration, so that the width of the receiving region can be adjusted in a flexible way. As a result, the width of the receiving region can be set in such a way that it corresponds substantially to the thickness of the glass door leaf to be received. It is thus ensured that there is always sufficient play between the door leaf and the holder and/or mating holder, so that a smooth sliding of the door leaf into and out of the receiving region is ensured. It is also prevented at the same time that there is too much play, through which the door leaf would move back and forth in the latch and might thus be damaged. Moreover, excessive play reduces the tightness of the door. Furthermore, an optimally set play minimizes disturbing rattling noises, as a result of which the door opening and closing process can occur in a quieter manner. A further advantage of the invention is that stock-keeping can be reduced because the adjustability of the receiving area allows using a latch for several glass doors with different glass thicknesses. Installation of the door opener is also simplified because the receiving region can be adjusted individually at the installation location and it is not necessary to separately exchange the entire door opener.

In order to prevent jamming during the insertion of the door into the receiving region, the mating holder can be provided with a resilient configuration. The door opener can also be arranged in such a way that it is fastened by means of oblong holes to a closing plate. The oblong holes can be arranged either on the door opener or on the closing plate.

The receiving region is provided with a substantially U-shaped arrangement in a preferred embodiment. The arrangement of the receiving region in this shape is appropriate because it corresponds to most of the standard profiles of glass doors and the receiving region and the door leaf can thus cooperate best together. One leg of a U is appropriately formed in this embodiment by the holder and the other leg by the mating holder. The region connecting the area of the two legs of the U can be formed either by the latch body, the holder or the mating holder. The U-shaped arrangement of the receiving region ensures that a secure overlap occurs of the edge of the door leaf in the closed position.

The holder is arranged with an L-shaped profile in a further preferred embodiment. The one L-leg is used for laterally delimiting the receiving region and the other leg as the guide surface and rests on the latch body. The holder with the L-shaped profile is used especially preferably in a receiving region arranged in a U-shaped manner, with one L-leg of the holder forming the connection between the two legs of the U of the receiving region and thus being opposite to the face surface of the door leaf in the closed position.

The movement of the holder during the displacement appropriately occurs in a substantially linear way. When the receiving region is arranged in a U-shaped manner, it is further appropriate that the holder is movable along the plane of the receiving region which connects the two legs of the U. In this way, one of the legs of the U of the receiving region can be displaced parallel to the other leg of the U, as a result of which the width of the receiving region is adjustable. In a further preferred embodiment, the holder is displaceable fastened to the latch body. The adjustment of the holder for the adjustability of the width of the receiving region can thus be performed in an especially simple way. The displaceable fastening of the holder to the latch body can be arranged in such a way that the holder can be displaced when in direct contact with the latch body along the surface of the latch body. The two contact surfaces of holder and latch body are appropriately provided with a planar configuration in this embodiment. The displacement can also occur in such a way for example that the holder is dismounted from the latch body from an initial position and is mounted again at a new position laterally displaced from the initial position. Fastening occurs in such a way that the contact of the holder on the latch body is secured at all times and the same is unable to detach from the latch body. It is further appropriate to arrange the fastening in such a way that the holder can be arrested in a position in the adjusting direction. Such arresting can be provided with a detachable configuration, so that the holder can be set to a different position and can be arrested there again.

In a further preferred embodiment, the holder is fastened by means of a screwed connection to the latch body. Suitable breakthroughs must be arranged on the holder and screw holes corresponding to the breakthroughs must be arranged on the latch body, by means of which the holder can be screwed onto the latch body. The adjustability of the holder can be achieved in such a way that several screw holes are arranged on the latch body, so that the holder can be screwed off from one position and screwed on again in the next position in other screw holes. The adjustability of the holder is preferably achieved in such a way that oblong holes are provided as breakthroughs in the holder. The oblong holes must be arranged in such a way that their longitudinal axis corresponds substantially with the adjusting direction of the holder. This improves handling, because the screws need not be screwed completely out of the latch body. Instead, they only need to be loosened slightly and are adjustable and displaceable already after a slight loosening of the holder. Moreover, a guidance during the displacement of the holder is predetermined by the oblong holes. The use of oblong holes also allows a continued displacement, whereas one is limited to certain positions of the holder when using several screw holes on the latch body.

In a preferred embodiment, the holder is adjustable incrementally, i.e. step by step. The door opener must be arranged in such a way that certain adjustment steps are predetermined between which the holder is adjustable. It is preferable in this context that the adjustment steps are adapted in such a way that widths of the receiving regions produced by the respective adjustment steps are adjusted to the thicknesses of standardized glass door leafs. Standards for door leaf thicknesses are for example 9, 10, 12 or 15 mm. Handling is thus improved in the respect that a fitter can carry out the adjustment of the door opener to the optimal receiving region width for the respectively available glass door by adjusting the holder to the adjustment step corresponding to the glass door. In order to simplify handling, markings can be present on the holder or latch body which indicate the standard dimension to which the respective adjustment step corresponds.

The step by step adjustability of the holder is achieved in such a way in an especially preferable manner that a toothed grid is arranged between the holder and the latch body. Both surfaces mutually in contact are provided with teeth which engage into each other. For adjusting the holder, the arrest of the holder such as a screwed connection with oblong holes is detached. The holder can then be brought to a new position and then be arrested again. The toothed surfaces on the holder and latch body are substantially provided with the same shape and the distance between two teeth in the adjustment direction determines the length of the adjustment step. It is advantageous here that a toothed grid can be provided simply and at low cost. Adjustment steps can thus be predetermined in a simple and precise way.

In a further preferred embodiment, an adjusting screw is provided on the door opener. The adjusting screw is connected with the holder by means of a suitable gearing in such a way that the holder is adjusted by actuating the adjusting screw. The adjusting screw is appropriately aligned parallel to the direction of displacement of the holder. This enables a continuous, progressive possibility for adjustment, so that the door opener can be adjusted optimally to non-standardized, specially produced glass doors.

In order to further reduce the noise development it is appropriate to arrange an elastomeric material on at least one of the sides of the receiving region facing the glass door leaf in the closed position. The elastomeric material is preferably arranged in the manner of a coating on at least one of the walls. The elastomeric material is arranged in an especially preferable way to the inside of the holder and/or the mating holder. A sealing rubber can be used for example as an elastomeric material. A further advantage of this embodiment is a reduction in the likelihood of breaking the door glass leaf because the stop of the door leaf on the holder or mating holder is dampened by the elastomeric material. Furthermore, the tightness of the door opener is improved.

In order to enable the use of the door opener for the largest possible bandwidth of glass doors of different glass thicknesses, it is preferable to provide several different holders which can be exchanged with each other. The holders are dimensioned in such a way that each holder is adjustable within another interval of the width of the receiving region. The length of the individual adjusting paths of the respective holders can be provided with the same or different dimension. It is preferable for example to provide a door opener with two mutually exchangeable holders, with the adjusting path in both holders being 3 mm at most. The one holder is arranged in such a way that widths of the receiving regions in the range of 9 to 12 mm are obtained. Widths of the receiving regions in the range of 13 to 16 mm are obtained in the other holder. When a screwed connection with oblong holes is used for example for displaceably fastening the holder to the latch body, the holders can be exchanged simply by detaching and subsequently fixing the screwed connection. The holders are thus easily exchangeable at the installation location by the respective fitters.

In a further preferred embodiment, the receiving region is provided with a U-shaped configuration and the door opener is provided with a door opener cover. The legs of the U of the receiving region are aligned in such a way that in the closed position they are arranged substantially in a plane parallel to the door opener cover. Such an arrangement comes with the advantage that the door opener can also be mounted on thin carriers such as other glass door leafs and the receiving region is still aligned in such a way that it can receive the glass door to be received.

### BRIEF DESCRIPTION OF THE DRAWINGS

The invention is described below in closer detail by reference to embodiments schematically shown in the drawings, wherein:

FIG. 1 shows a sectional view of a first door opener in the closed position with received glass door leaf;

FIG. 2 shows the representation of FIG. 1 with the pivot latch in the opened position;

FIG. 3 shows the representation of FIG. 1 with damping rubbers on the holder and the mating holder;

FIG. 4 shows a perspective side view of a second door opener in the closed position;

FIG. 5 shows a further perspective view of the door opener of FIG. 4 with the pivot latch in the opened position;

FIG. 6 shows the illustration of FIG. 4 with adjusted holder, and

FIG. 7 shows the representation of FIG. 5 with adjusted holder.

The same components are provided with the same reference numerals in the embodiments shown below.

### DETAILED DESCRIPTION

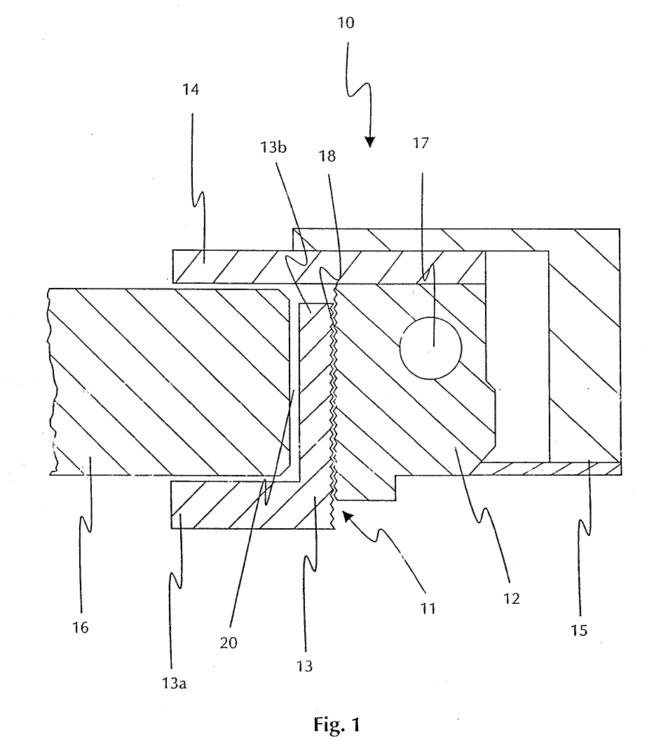

FIG. 1 shows a sectional view of a door opener 10 for glass doors. The door opener 10 is in the closed position. The door opener latch 11 is pivotably held on a pivoting axle 17. The door opener 10 comprises a door opener housing 15 in which the latch 11 is arranged. The door opener latch 11 consists of a latch body 12 and an L-shaped holder 13 whose one arm 13a of the L forms the one leg of the U of the U-shaped receiving region 20 and whose other arm 13 of the L acts as a bearing surface and rests on the latch body 12. The contact surfaces of the arm 13b and the latch body 12 which rest on each other are arranged as a tooth grid 18. The holder 13 can be adjusted along the tooth grid 18, with the distance between two teeth predetermining the length of one adjustment step each.

The U-shaped receiving region 20 is also delimited by the arm 13b and the mating holder 14 in addition to the arm 13a of holder 13, with the mating holder 14 and the arm 13a forming the legs of the U of the receiving region. The mating holder 14 is arranged as a stop plate which rests on one side of the latch body 12 and protrudes from the door opener 10. The mating holder 14 is further rigidly attached to the latch body 12 and is thus pivotable together with the same. The boundary region of a glass door leaf 16 is located within the receiving region 20. The boundary region of the door leaf 16 which is overlapped by the receiving region 20 has play laterally and on the face side against the boundaries of the receiving region 20. Play is set in such a way that it is possible to achieve an optimal sliding of the door 16 into the receiving region 20 and out of the receiving region 20.

Holder 13 is connected with the latch body 12 by means of a screwed connection with oblong holes (not shown here). By loosening the screwed connection it is possible to move the holder 13 transversally to the glass door leaf 16 and thus to increase or reduce the width of the receiving region 20. When the arm 13b is moved in the axial direction relative to the mating holder 14, the width of the receiving region decreases. The width of the receiving region 20 increases in the case of reverse direction of movement.

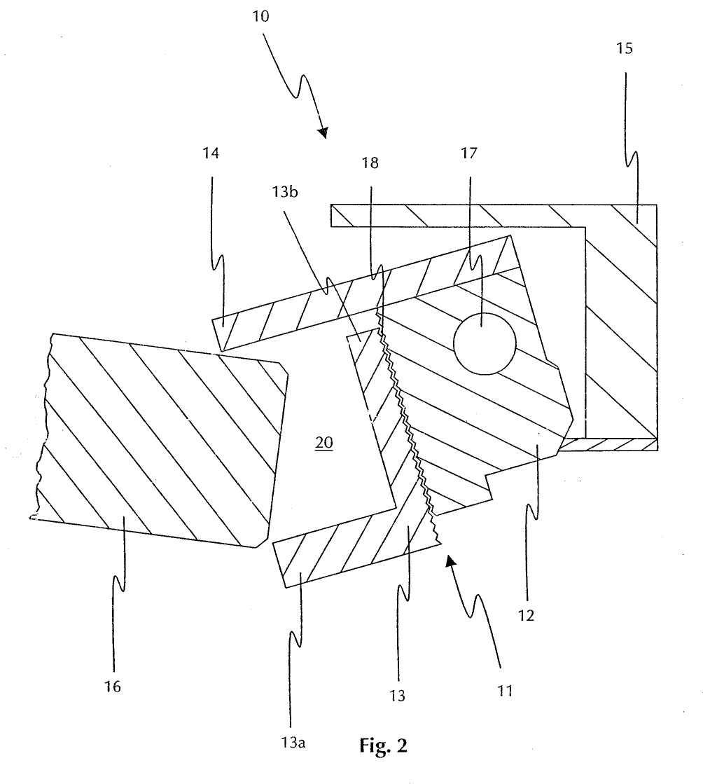

FIG. 2 shows the door opener of FIG. 1, with the pivot latch 11 being in the pivoted state. Door opener latch 11 was released by means of a suitable positioning element (not shown here) and was able to pivot out of the housing 15. The door leaf 16 is thus released and is able to slide out of the receiving region 20. The width of the receiving region 20 is adjusted to the thickness of the door leaf 16 in such a way that the sliding of door leaf 16 into and out of the receiving region 20 occurs without hitting the holder 13 or the mating holder 14.

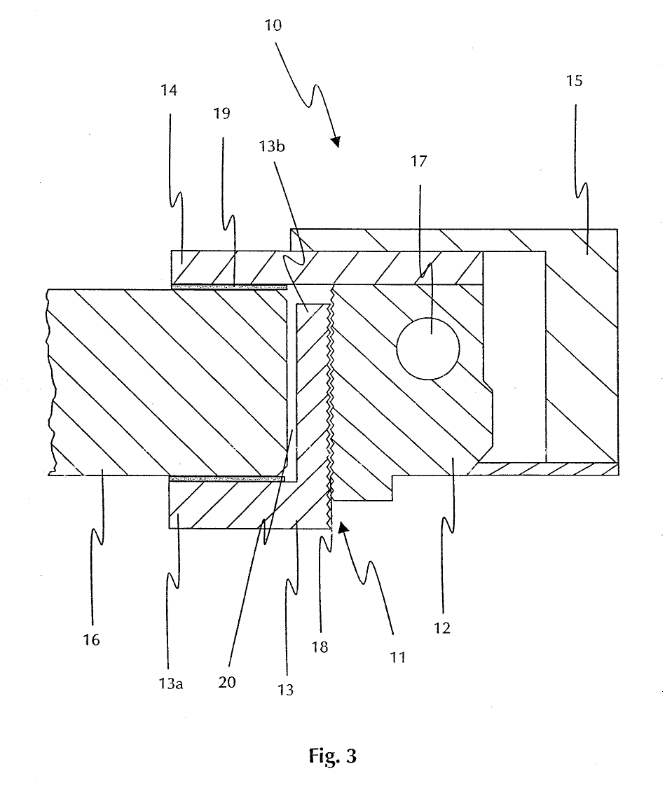

The representation shown in FIG. 3 substantially shows the representation of FIG. 1, with damping rubber 19 each being attached to the inside of the arm 13a and the mating holder 14. In the closed position, the play between the arm 13a of the holder 13 and/or the mating holder 14 and the door leaf 16 is filled by the sealing rubber 19. This helps reduce the noise caused during the opening and closing of the door. Moreover, the tightness of the door opener 10 is improved and the likelihood of damage to the glass door leaf 16 is reduced.

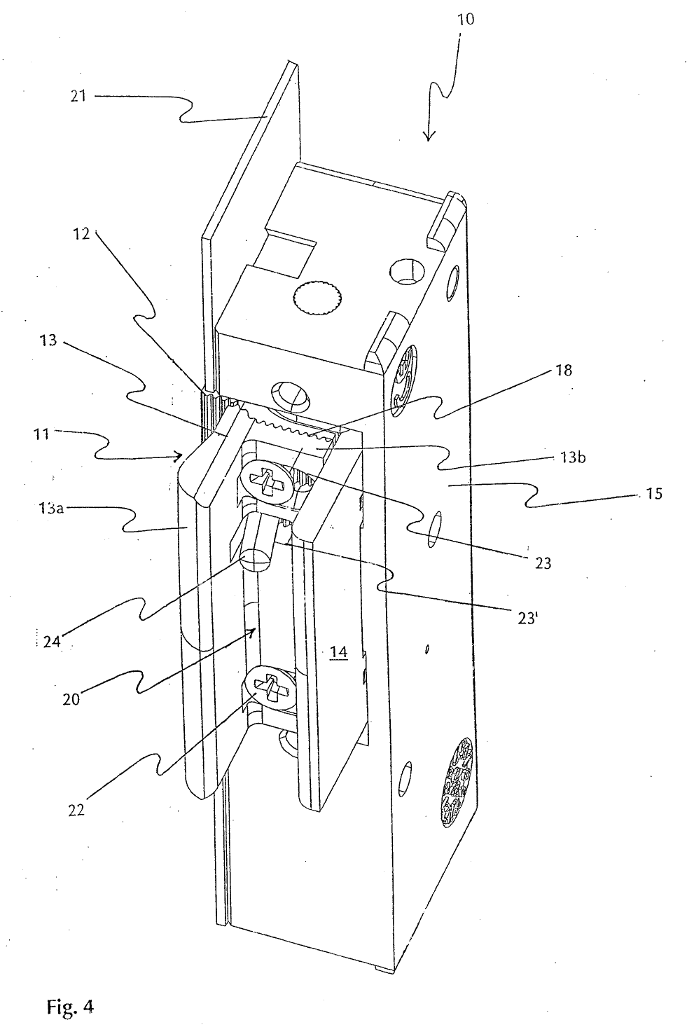

FIG. 4 shows a further embodiment of an electric door opener 10 for glass doors in a perspective view. The receiving region 20 is also U-shaped and arranged similar to the receiving region of the door opener of FIGS. 1 to 3. The holder 13 is L-shaped and the contact surface to the latch body 12 is arranged as a tooth grid 18. The holder 13 is fastened with a screw joint 22 to the latch body 12. The screw joint 22 comprises two oblong holes 23 whose longitudinal axis extends transversally to the door opener 10. In contrast to the door opener of FIGS. 1 to 3, the mating holder 14 is not attached to latch body 12 but to the door opener housing 15 and thus does not pivot during the pivoting of latch 11. Latch 11 is further aligned in such a way that the legs of the U of the receiving region 20 are arranged in a co-planar manner relative to the door opener cover 21. The door opener cover 21 protrudes at least on one face side beyond the door opener housing 15 and closes off the door opener 10. As a result of this alignment of the latch 11, the door opener 10 can be fastened to a relatively thin carrier such as the wing of a double-wing glass door. At the same time, the latch 11 is aligned to receive the other wing of the double-wing glass door in the receiving region 20.

A further oblong hole 23′ is arranged in the arm 13b of the holder 13 between the two oblong holes 23 of the screwed connection 22, by means of which a securing pin 24 mounted on the latch body protrudes from the latch body 12 approximately parallel to the legs of the receiving region 20. The arrangement of the oblong hole 23′ ensures that the holder 13 can be adjusted without being blocked by the locking pin 24. The oblong hole 23′ is arranged with the same shape as the oblong holes 23 and is aligned in coincidence with the same. After receiving a door leaf (not shown here), the locking pin 24 is pressed into the latch body 12 by the face surface of the received boundary region of the door leaf, as a result of which a latching mechanism is released. The locking pin 24 is adjusted in such a way that the door releases the latching mechanism at the time at which the latch 11 has been pivoted fully into the door opener housing 15. Only by actuating the positioning element (not shown here) will the latching mechanism be released again and the latch 11 will be released for pivoting. In order to ensure precise switching of the securing pin 24, an optimally set play is necessary between the face side of the door leaf and the arm 13b of the holder 14 in the closed position. Favorable results can be achieved when maximum play does not exceed more than 3 mm.

In the illustration shown in FIG. 4, the width of the receiving region 20 is in the minimal range, i.e. the outside edge of the long side of the arm 13b of the holder 13 rests on the inside surface of mating holder 14. In order to enlarge the width of receiving region 20, the holder 13 would need to be moved to the outside away from the mating holder 14.

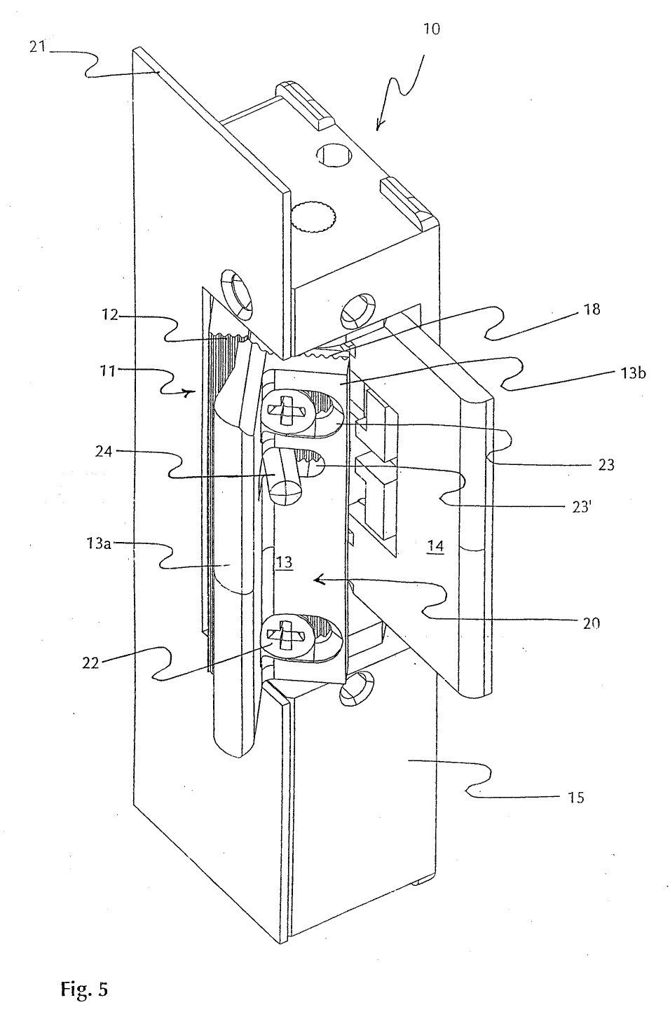

The illustration shown in FIG. 5 shows the door opener of FIG. 4, with the pivot latch 11 being in the pivoted state. Since the mating holder 14 is fastened to the door opener housing 15, it is stationary and does not pivot together with the pivot latch 11.

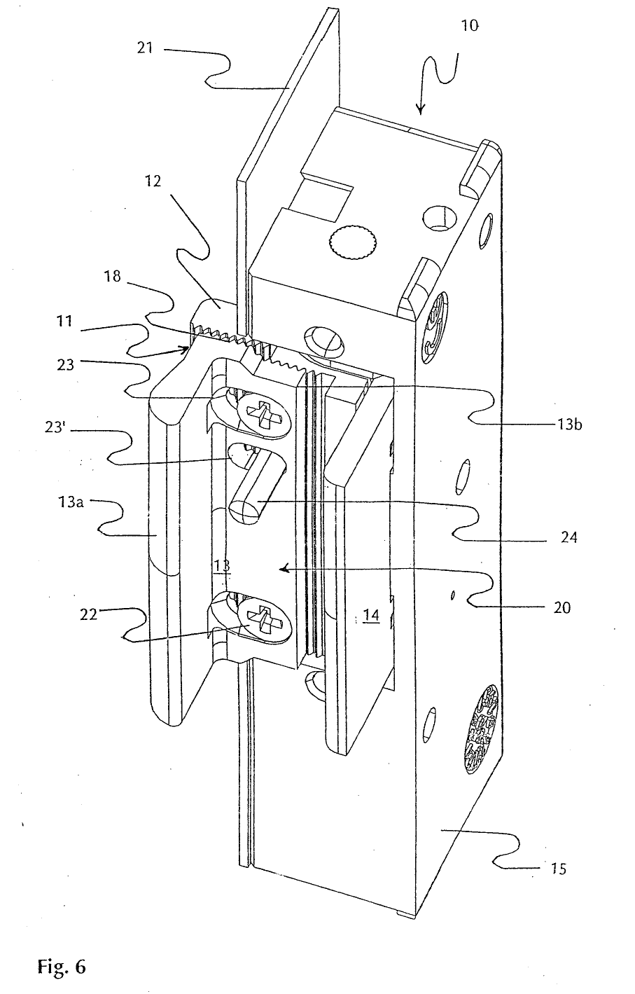

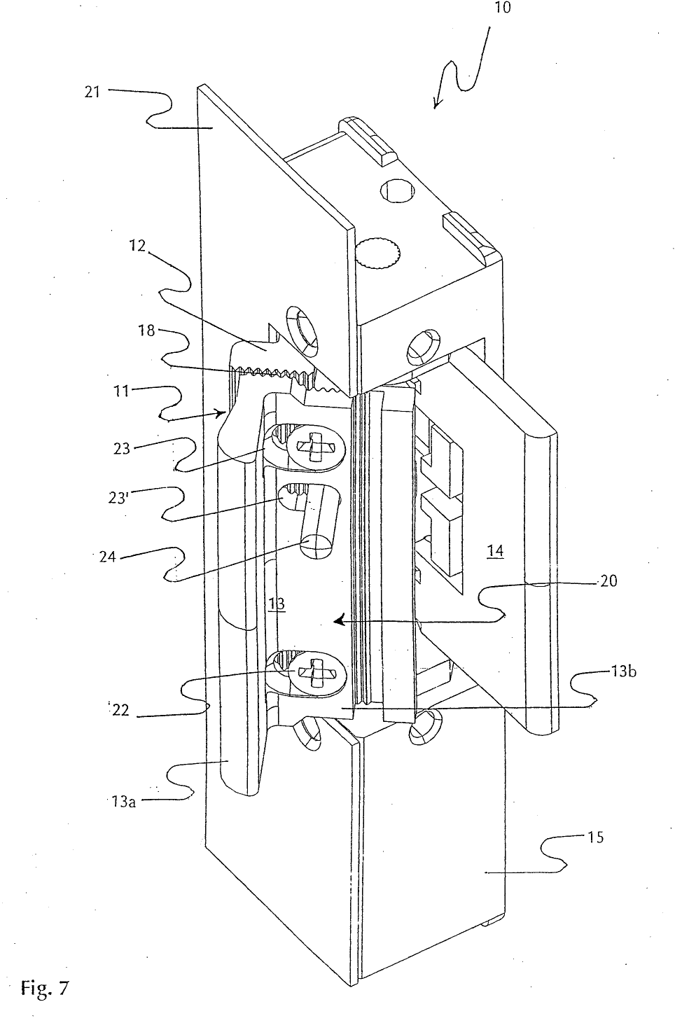

FIGS. 6 and 7 show the door opener of FIGS. 4 and 5, with the holder having been adjusted, so that a maximum width of the receiving region 20 is obtained. The maximum adjustment path is predetermined by the dimensions of the oblong holes 23.

What is claimed is:

1. An electric door opener for glass doors, comprising a pivotable door opener latch comprising a holder, and a mating holder, with the holder and the mating holder delimiting a receiving region for receiving a glass door leaf, wherein the holder is provided with an adjustable configuration to ensure adjustability of the width of the receiving region.

2. A door opener according to claim 1, wherein the receiving region is provided with a substantially U-shaped configuration, with a leg of the U being formed by the holder and the other leg of the U by the mating holder.

3. A door opener according to claim 1, wherein the holder has an L-shaped profile, with the one leg being formed for delimiting the receiving region and the other leg being formed as a bearing surface resting on the latch body.

4. A door opener according to claim 1, wherein the holder is fastened in a displaceable manner to the latch body.

5. A door opener according to claim 1, wherein the holder is fastened by means of a screwed connection to the latch body.

6. A door opener according to claim 5, wherein the screwed connection comprises oblong holes.

7. A door opener according to claim 1, wherein the holder is adjustable in an incremental way.

8. A door opener according to claim 7, wherein the adjustment steps are adjusted to the thicknesses of standardized glass door leafs.

9. A door opener according to claim 7, wherein a toothed grid is arranged between the holder and the latch body for incremental adjustment.

10. A door opener according to claim 1, wherein an adjusting screw is present which is connected via a gearing with the holder and by means of which the holder is adjustable.

11. A door opener according to claim 10, wherein the adjusting screw is arranged substantially parallel to the direction of displacement of the holder.

12. A door opener according to claim 1, wherein an elastomeric material is arranged at least on one side of the receiving region facing the glass door leaf in the closed position.

13. A door opener according to claim 1, wherein several different and exchangeable holders are present, with a different width interval of the receiving region being obtained in each holder.

14. A door opener according to claim 2, with a door opener cover wherein the legs of the U of the receiving region are arranged substantially parallel to the door opener cover in the closed position.
